(19) United States
(12) Patent Application Publication
(10) Pub. No.: US 2004/0088375 A1
(43) Pub. Date: May 6, 2004

(54) Method for prefetching Web pages to improve response time networking

(76) Inventors: Bhupinder S. Sethi, Redmond, WA (US); Michael R. Fortin, Redmond, WA (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/285,820

(22) Filed: Nov. 1, 2002

(51) Int. Cl. G06F 15/16

(52) U.S. Cl. 709/218; 709/228

(57) ABSTRACT

Mechanisms for prefetching without requiring parsing of a Web page. References to associated images, sound, video, and executable files and hyperlinked Web pages are included in the header portion of the network message used to deliver the Web page. The associated resources may include properly identified resources (e.g., images and sounds) that are to be rendered with the image, or which are known to have a high probability (if not a certainty) of being selected. The associated resources may also included other resources (e.g., hyperlinked Web pages) that have a lesser probability of being selected and which are only retrieved when there is a detected period of browser idle time. That period of idle time is selected such that it is less likely that the user is going to issue an express request for another Web page during a prefetching operation.

### BACKGROUND OF THE INVENTION

1. The Field of the Invention

The present invention relates to mechanisms for prefetching resources associated with Web pages. In particular, the present invention relates to mechanisms for prefetching resources without having to necessarily parse the Web page and while distinguishing between those resources that are to be retrieved immediately and those resources that are only to be retrieved after a period of idle time.

2. Related Technology

Computing technology has transformed the way we work and play. Computer networking, in particular, allows individual computers to communicate information between each other. Computer networks can be conglomerated together to allow for expansive communication. The Internet, for example, is a well-known global computer network that consists of amalgamations of smaller interconnected networks.

One primary use of a network is to allow users or applications to access remotely-stored information such as Web pages. Accessing a Web page involves establishing a logical connection with a server that stores the Web page, downloading the Web page, parsing through the Web page to identify associated resources (such as images, sound files, video, executables or the like) that are to be rendered with the Web page, and then potentially retrieving those associated resources as well. From a user's perspective, the user perceives a delay between the time that she requests a Web page and the time that the Web page is fully rendered. This delay is often referred to as “latency.” Such latency can become quite noticeable especially when using lower bandwidth network connections such as dial-up connections.

In order to obscure the appearance of latency from the user, a technology called “prefetching” has been developed and is in widespread use. Prefetching involves the automatically acquisition of associated resources such as Web pages hyperlinked in the Web page without waiting for an express user request for the other associated resources. Should the user then select a hyperlink in the Web page, there is a possibility that the hyperlinked Web page may have already been prefetched. If the Web page has already been prefetched, then the browser acquires the Web page locally, rather than remotely from the server. Accordingly, latency may be dramatically reduced in some cases.

Conventional prefetching requires that the browser first parse through the Web page to identify potentially candidates for prefetching. For example, conventional prefetching involves the substantially immediate acquisition of image, sound, video, or executable files that are to be rendered with the Web page. Once the main Web page and the associated executable resources are retrieved, the prefetching mechanism may then acquire hyperlinked Web pages that are referenced in the main Web page.

One problem with this conventional prefetching mechanism is that parsing of the HTML code that represents the Web page is typically begun prior to any prefetching. HTML parsing can take significant time and thus may itself introduce latency even though prefetching is involved. In addition, sometimes the HTML content in the body of the HTTP response is in compressed form thereby requiring decompression before HTML parsing can even begin, thereby further increasing latency. HTML parsing may not even be possible in some intermediate proxies.

Also, there is a distinct possibility that a user may have requested a Web page of interest while the browser is in the process of prefetching another Web page that is not of interest. In that case, the user would typically have to wait for the undesired Web page to be downloaded before downloading of the desired Web page can begin. This can actually increase latency in some cases over not performing prefetching at all.

In addition, conventional prefetching techniques involve the acquisition of associated resources or Web pages over a network. However, there is often significant latency in acquiring associated resources even when the resources are stored within a local disk. If the disk access speed is relatively slow (as when a laptop is being used) and/or the associated resource to be accessed is relatively large (as when a video is associated with the Web page), latency can be quite frustrating to a user even though the associated resource of the Web page has been stored in local persistent memory.

### BRIEF SUMMARY OF THE INVENTION

The foregoing problems with the prior state of prefetching mechanisms are overcome by the principles of the present invention, which relate to prefetching mechanisms that do not necessarily require any Web page parsing prior to initiating prefetching, while reducing the chance that the prefetching of an undesired Web page will interfere with an express user request for another Web page. The prefetching mechanisms may be used to reduce latency when associated resources of a Web page are stored locally in persistent memory, as well as when the associated resources are stored remotely over a network.

References to associated prefetchable resources may be included in the header portion of a network message (e.g., in the header portion of an HTTP response), rather than exclusively in the Web page itself. Accordingly, prefetching may begin immediately after reading the header portion even if parsing of the Web page in the body portion of the network message has not yet begun.

Whether or not the associated resources are identified in the header portion of the network message, the associated resources may be divided into two general categories. One category referred to herein as “short term” resources includes resources that are to be retrieved immediately. Such resources may be, for example, images, sounds, videos or an executable file (such as a Java applet or a Flash file) that are to be rendered with the Web page and/or resources (such as redirection Web pages) that have a high or certain likelihood of being selected and their associated image, sound, video, or executable files. Another category referred to herein as “long term” resources includes resources that are less certain to be retrieved and are not necessarily needed to properly render the current Web page and their associated image, sound, video, or executable files. Such resources may include one or more of several hyperlinked Web pages referenced in the associated Web page and their associated image, sound, video, or executable files.

The long term resources are only retrieved after a detected period of idle time. For example, if the browser has not issued any user generated requests for other Web pages within a certain time period, there may be a lower likelihood that a request may be issued in the next few seconds. Accordingly, after the idle period, the browser may prefetch the long term resources.

A probability of selection may be associated with each of the long term resources. If so, the browser may prefetch the long term resources (and/or their associated image, sound, video or executable files) in order of descending probability. Also, the designated idle period may be different for each resource depending on the assigned probability of selection. The probability of selection may be assigned by the server that hosts the main Web page based on observation of past activities of the user or of a group of users. Accordingly, prefetching is less likely to delay an express user request for another Web page, and thus average latency time is reduced.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-described and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a suitable computing system in which the principles of the present invention may be employed;

FIG. 2 illustrates a network environment in which the principles of the present invention may be employed;

FIG. 3 illustrates a flowchart of a method for prefetching in which parsing of the Web page itself is not necessary in order to initiate prefetching, and in which prefetching is less likely to interfere with user requests for other Web pages; and

FIG. 4 illustrates a data structure of a network message in accordance with the principles of the present invention.

### DETAILED DESCRIPTION OF THE PREFERRED EMBODIMENTS

The principles of the present invention relate to mechanisms for prefetching without necessarily requiring parsing of a Web page by including references to the associated resources (e.g., images, sound, video, executables and hyperlinked Web pages) associated with the Web page in the header portion of the network message itself. The associated resources may include properly identified resources (e.g., images and sounds) that are to be rendered with the image, or which are known to have a high probability (if not a certainty) of being selected. The associated resources may also include other resources (e.g., hyperlinked Web pages and/or the hyperlinked page's associated image, sound, video and executable files) that have a lesser probability of being selected and which are only retrieved when there is a detected period of browser idle time. That period of idle time is selected such that it is less likely that the user is going to issue an express request for another Web page during a prefetching operation.

Embodiments within the scope of the present invention include computer-readable media for carrying or having computer-executable instructions or data structures stored thereon. Such computer-readable media can be any available media which can be accessed by a general purpose or special purpose computer. By way of example, and not limitation, such computer-readable media can comprise physical computer-readable media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer.

When information is transferred or provided over a network or another communications connection (either hardwired, wireless, or a combination of hardwired or wireless or over a system bus from the disk) to a computer, the computer properly views the connection as a computer-readable medium. Thus, any such a connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

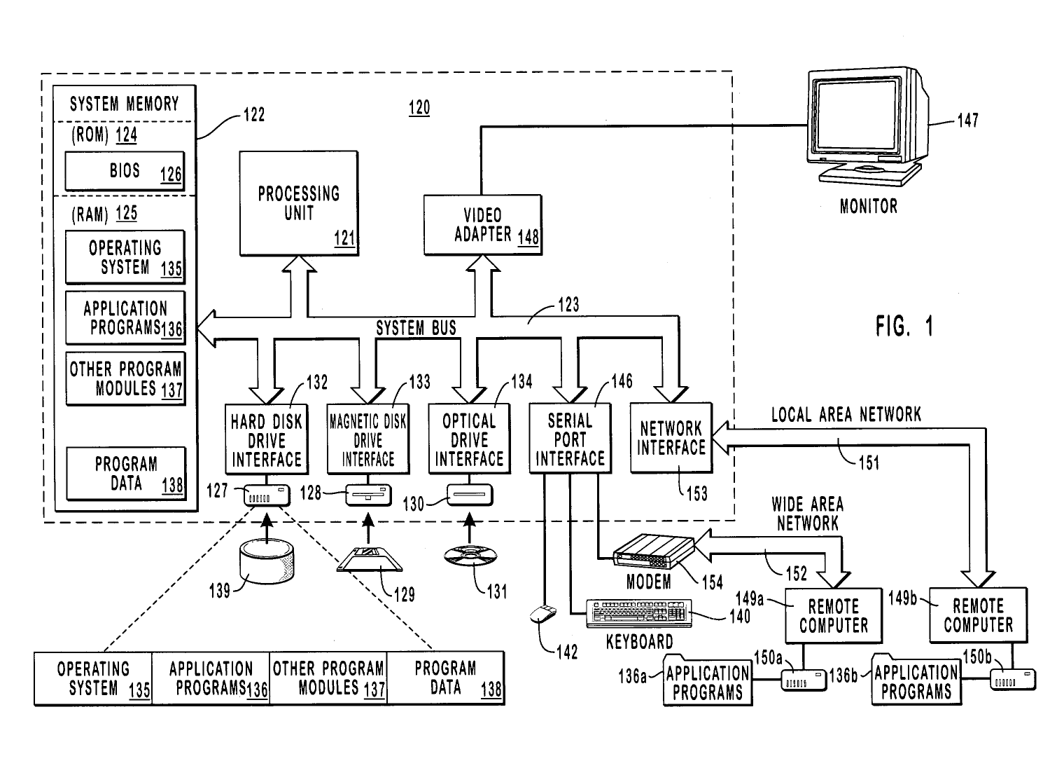

FIG. 1 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, and the like, that perform particular tasks or implement particular abstract data types.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 1, an example system for implementing the invention includes a general purpose computing device in the form of a conventional computer 120, including a processing unit 121, a system memory 122, and a system bus 123 that couples various system components (including the system memory 122) to the processing unit 121.

The system bus 123 may be any of several types of bus structures including a memory bus or memory controller, a peripheral bus, and a local bus using any of a variety of bus architectures. The system memory includes read only memory (ROM) 124 and random access memory (RAM) 125. A basic input/output system (BIOS) 126, containing the basic routines that help transfer information between elements within the computer 120, such as during start-up, may be stored in ROM 124.

The computer 120 may also include a magnetic hard disk drive 127 for reading from and writing to a magnetic hard disk 139, a magnetic disk drive 128 for reading from or writing to a removable magnetic disk 129, and an optical disk drive 130 for reading from or writing to removable optical disk 131 such as a CD-ROM or other optical media. The magnetic hard disk drive 127, magnetic disk drive 128, and optical disk drive 130 are connected to the system bus 123 by a hard disk drive interface 132, a magnetic disk drive-interface 133, and an optical drive interface 134, respectively. The drives and their associated computer-readable media provide nonvolatile storage of computer-executable instructions, data structures, program modules and other data for the computer 120. Although the exemplary environment described herein employs a magnetic hard disk 139, a removable magnetic disk 129 and a removable optical disk 131, other types of computer readable media for storing data can be used, including magnetic cassettes, flash memory cards, digital video disks, Bernoulli cartridges, RAMs, ROMs, and the like.

Program code means comprising one or more program modules may be stored on the hard disk 139, magnetic disk 129, optical disk 131, ROM 124 or RAM 125, including an operating system 135, one or more application programs 136, other program modules 137, and program data 138. A user may enter commands and information into the computer 120 through keyboard 140, pointing device 142, or other input devices (not shown), such as a microphone, joy stick, game pad, satellite dish, scanner, or the like. These and other input devices are often connected to the processing unit 121 through a serial port interface 146 coupled to system bus 123. Alternatively, the input devices may be connected by other interfaces, such as a parallel port, a game port or a universal serial bus (USB). A monitor 147 or another display device is also connected to system bus 123 via an interface, such as video adapter 148. In addition to the monitor, personal computers typically include other peripheral output devices (not shown), such as speakers and printers.

The computer 120 may operate in a networked environment using logical connections to one or more remote computers, such as remote computers 149a and 149b. Remote computers 149a and 149b may each be another personal computer, a server, a router, a network PC, a peer device or other common network node, and typically include many or all of the elements described above relative to the computer 120, although only memory storage devices 150a and 150b and their associated application programs 136a and 136b have been illustrated in FIG. 1. The logical connections depicted in FIG. 1 include a local area network (LAN) 151 and a wide area network (WAN) 152 that are presented here by way of example and not limitation. Such networking environments are commonplace in office-wide or enterprise-wide computer networks, intranets and the Internet.

When used in a LAN networking environment, the computer 120 is connected to the local network 151 through a network interface or adapter 153. When used in a WAN networking environment, the computer 120 may include a modem 154, a wireless link, or other means for establishing communications over the wide area network 152, such as the Internet. The modem 154, which may be internal or external, is connected to the system bus 123 via the serial port interface 146. In a networked environment, program modules depicted relative to the computer 120, or portions thereof, may be stored in the remote memory storage device. It will be appreciated that the network connections shown are exemplary and other means of establishing communications over wide area network 152 may be used.

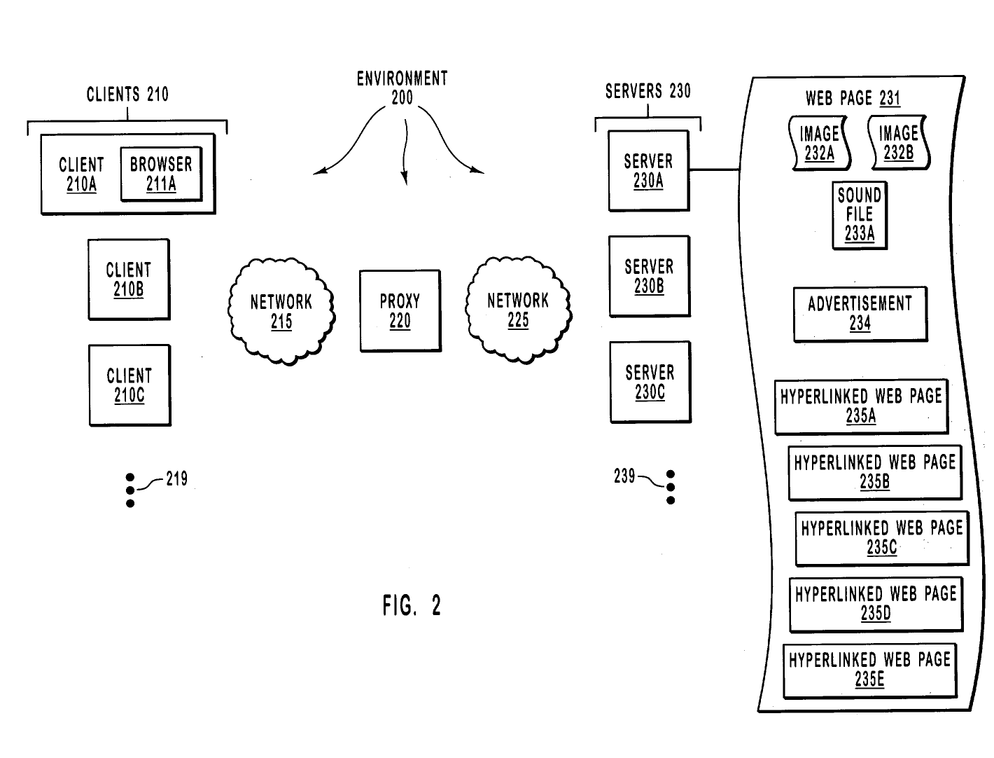

FIG. 2 illustrates an environment 200 in which the principles of the present invention may be employed. The network environment includes client computer systems 210 (including client computer systems 210A, 210B and 210C) that are network connectable to server computing system 230 (including server computing systems 230A, 230B and 230C) potentially via a proxy computer system 220. The client computer systems 210 are network connectable to the proxy server computer system 220 (and potentially to each other) over a network 215, while the server computer systems 230 are network connectable to the proxy computer system 220 (and potentially to each other) over a network 225. The network 215 may be, for example, a local area network, while the network 225 may be, for example, the Internet.

In this description and in the following claims, two computer systems are “network connectable” when they have the ability to be persistently or temporarily network connected to each other. In this description and in the claims, two computer systems are “network connected” to each other when they have the ability to communicate with each other through one or more intervening networks.

While only three client computer systems 210A through 210C are shown, the proxy server computer system 220 may act as a proxy for any number of client computer systems as represented by vertical ellipsis 219. Furthermore, while only three server computer systems 230A through 230C are shown, the proxy server computer system 220 may be network connectable to any number of server computer systems as represented by the vertical ellipsis 239. If the network 225 were the Internet, for example, the server computer systems 230 may be practically uncountable.

Although not required, each of the client computing systems 210, the proxy computer system 220, and the server computer systems 230 may take the form of the computer 120 described above with respect to FIG. 1. However, the computer systems may take any other form so long as they are able to process electronic instructions. For example, the client computer systems 210 may be desktop computers, laptop computers, personal digital assistants, telephones with browsing capability, or the like.

In a specific example, suppose that client computer system 210A is to acquire a Web page 231 from server computer system. Conventionally, a Web page may include a number of multimedia elements for rendering with the Web page, as well as one or more hyperlinked Uniform Resource Identifiers (URIs) that a user may select to automatically acquire a corresponding network resource such as a Web page. For example, Web page 231 includes several images 232A and 232B to be rendered within the framework of the Web page 231, a sound file 233A to be rendered during the display of the Web page 231, an advertisement Web page 234 that corresponds to an advertisement that will by design be displayed with certainty on the same browser display that the Web page 231 is displayed on, and several hyperlinked Web pages 235A through 235E that represent other associated Web pages that a user may potentially select from various hyperlinks embedded in the Web page 231.

Of course, associated resources such as image, sound, video or executable files and other hyperlinked Web pages are not normally directly included within the code that represents the main Web page. Instead, only a reference (often called a “Uniform Resource Identifier” or “URI” for short) to these files and pages is included within the code that represents the main Web page. A typical language used to code a Web page is HyperText Markup Language (HTML). Once a browser parses the Web page (using, for example, an HTML parser), the browser automatically generates separate requests for each of the image, sound, video or executable files that are referenced in the code that represents the main Web page. In addition, the browser knows to generate separate requests for hyperlinked Web pages when the user selects an area of the display that is defined by the code as corresponding to the hypertext link. For example, a browser 211A associated with the client computer system 210A may first generate and submit to the server computer system 230A (via any potential proxies such as proxy server computer system 220) a request for the Web page 231.

Upon parsing through the code that represents the Web page 231, the browser would then know to automatically request image files 232A and 232B, sound files 233A, and then advertisement Web page 234. The browser 211A may then optionally retrieve one or more of Web pages 235A through 235E upon the detection of certain conditions. For example, the browser 211A may detect a user selection of a hyperlink associated with a hyperlinked Web page, or may decide to prefetch a hyperlinked Web page despite not having received an express user request for the Web page.

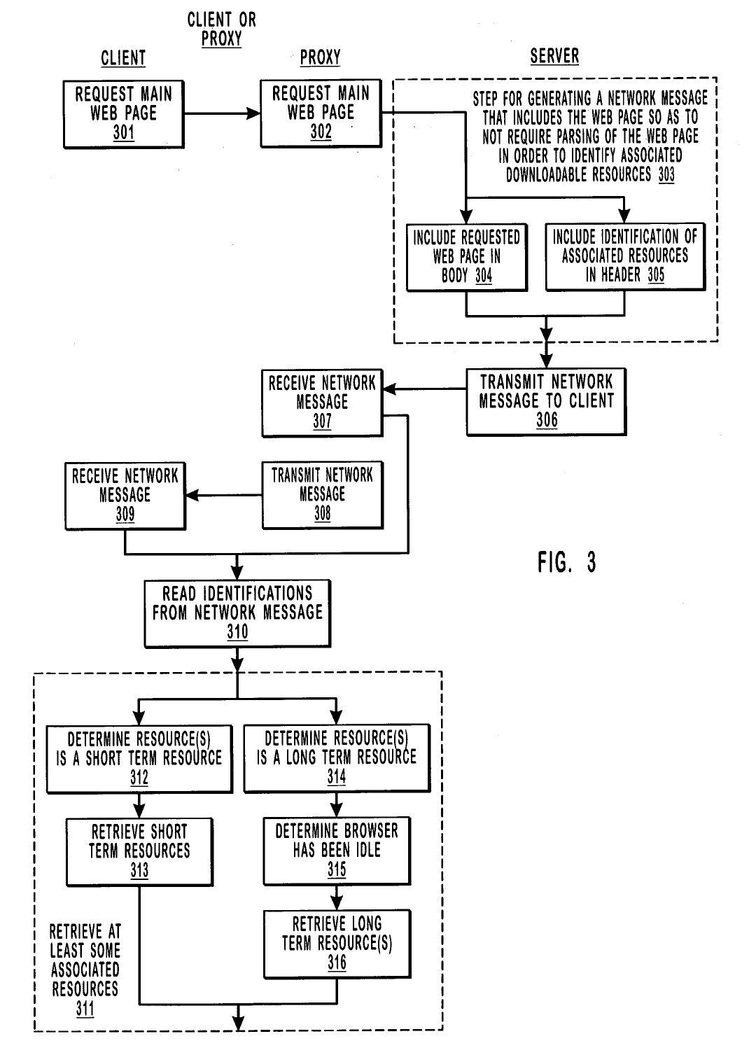

FIG. 3 illustrates a method for prefetching resources associated with a Web page in accordance with the principles of the present invention. Some of the acts in the method are performed by a client such as client computer system 210A as listed in the left column of FIG. 3 under the heading “CLIENT”. Some of the acts in the method are performed by a proxy such as proxy computer system 220 as listed in the middle column under the heading “PROXY”. Some of the acts are performed by a server such as server computer system 230A as listed in the right column under the heading “SERVER”. Yet other acts may be performed by either the client or the proxy as listed in the column between the left and middle columns under the heading “EITHER CLIENT OR PROXY” (see e.g., step 311 and corresponding acts 312 through 316).

Initially, the client computer system (such as client computer system 210A) issues a request for a main Web page (such as Web page 231) (see act 301). If a proxy is involved, the proxy (such as proxy computer system 220) will intercept the request and likewise generate and issue a request for the main Web page (act 302). A proxy is not necessary to implement many, if not all, of the features of the present invention. However, the listing of short term hints in the header portion of a network response is useful to reduce latency when a proxy is used as described in further detail below. The client could, however, issue the request directly to the server while remaining within the scope of the present invention.

Regardless of whether the Web page request comes directly from a client, or indirectly through a proxy, the server may then perform a functional, result-oriented step for generating a network message that includes the Web page so as to not require parsing of the Web page in order to identify associated prefetchable resources (step 303). The step 303 could include any corresponding acts for accomplishing this purpose. However, in the illustrated embodiment of FIG. 3, the step 303 includes corresponding acts 304 and 305.

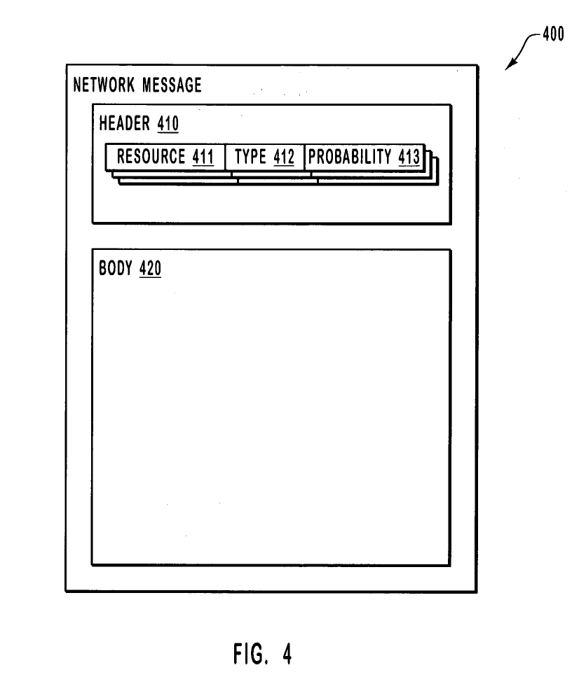

In particular, the server may include the requested Web page in the body of the network message (act 304). For example, if the network message is structured as a HyperText Transport Protocol (HTTP) response, the requested Web page may be included as a HyperText Markup Language (HTML) document within the body of the HTTP response network message. FIG. 4 illustrates a data structure 400 of a network message in accordance with the principles of the present invention. The data structure 400 includes a header field 410 and a body field 420. There may be a type field 412 for each resource or group of resources to identify whether the resource or group of resources is a long term resource or a short term resource. Also, a probability field 413 may be included for the long term resources in order to give an estimated probability that the user will request the associated long term resource. Although the type field 412 and the probability field 413 are illustrated as being included in the resource field 411, the type field 412 and the probability may be within or just somehow associated with the resource field 411 such that the client or proxy may determine whether any given resource is long term or short term, and the probability of being selected if long term. The requested Web page may be included in the body field 420 of the data structure.

In addition, the server includes identifications of prefetchable resources associated with the requested Web page in a header portion 410 of the data structure 400 that represents the network message. For example, if the network message is an HTTP response network message, the identifications may be included in the header portion of the HTTP response network message.

The server then transmits the network message to the client (act 306). If a proxy is involved, the proxy receives the Web page in the form of the network message (act 307). The proxy would then transmit the network message to the client upon receipt (act 308). Regardless of whether a proxy is involved, the network message is received by the client (act 309).

The remainder of the method illustrated in FIG. 3 may be performed by either the proxy or the client. If the client performs the remainder of the method, then the client begins acts 310 only after having received the network message that includes the Web page (act 309). If the proxy performs the remainder of the method, then the proxy begins act 310 only after having received the network message that includes the Web page (act 307). There is no need for the proxy to wait for the entire network message to be transmitted to the client (act 308) before continuing the method from act 310.

The method includes either the client or the proxy reading identifications of the prefetchable resources associated with the Web page from the network message (act 310). Although act 304 involves the inclusion of the identifications of the associated resources in the header portion of the network message, that need not be the case. The identifications of the associated resources may be included in other portions of the network message as well, although including an identification of particularly the short term resources in the header portion provides significant advantages when a proxy is being used.

In particular, if the proxy is reading identifications of the prefetchable resources (act 310), and those identifications are included in the header portion of the network message, the proxy need not first parse through the body of the network message before being able to identify the associated resources. Many proxies do not have an HTML parser. Accordingly, those proxies would not have been able to identify associated resources in an HTML coded Web page included in the body of an HTTP response. However, by including the identification of the associated resources in the header of the response network message (e.g., in the pragma header of the HTTP response headers), rather than in the body of the response network message (e.g., in the Web page HTML code itself), the principles of the present invention allow the proxy to obtain an identification of the associated resources even without a complicated HTML parser.

Further, even if an HTML parser were available, it can take some time to parse through the HTML code to find references to the associated resources, especially if the HTML code needed to be decompressed prior to parsing. By including the identification of the associated resource in the header, rather than in the body of the response network message, the identification of the associated resources may be made much more quickly, thereby reducing latency time.

The proxy or client then retrieves at least some of the plurality of prefetchable resources read from the header portion of the network message (act 311). In one example implementation, the associated resources include short term resources that are to be retrieved immediately as well as long term resources that are to be retrieved only after detecting a period of idle time on the client.

Accordingly, the proxy or client may determine that at least one of the plurality of prefetchable resources is to be retrieved substantially immediately (act 312) and then substantially immediately retrieves the least one prefetchable resource that is to be retrieved immediately (act 313). Such short term resources may include image, sound, video, executable or any other files that are to be rendered with the Web page, or perhaps other web pages (and their associated resources) that there is a very high, if not certain, chance of being requested. For example, the web page may be an advertisement that is automatically overlaid above the main Web page for a period of time or until closed by the user.

The proxy or client may retrieve the prefetchable resources from a network location. Alternatively, the prefetchable resource may even be loaded into system memory from a local persistent memory such as a local disk (if the resource had been previously cached). Depending on the access speed of the local persistent memory and the size of the prefetchable resource, there may be significant latency introduced from locally accessing the prefetchable resource from the persistent memory. By prefetching the resource from the local persistent memory into the faster system memory, latency may be reduced.

In one example implementation within the scope of the present invention, a client or proxy retrieves Web page 231, and then detects that hyperlinked Web page 235B is likely to be selected. In preparation, the client or proxy prefetches all of the associated resources (e.g., images, sounds, video, or executable files and potentially even Web pages hyperlinked in the hyperlinked Web page 235B and its associated resources and hyperlinked pages, as so forth and so on) of the Web page 235B from a local disk. As anticipated, the user then selects the hyperlink associated with Web page 235B. The client or proxy then retrieves the Web page 235B from the network or local disk. The associated resources had already been prefetched (or preloaded) into system memory. Accordingly, the Web page 235B is rendered with a much lower latency than if the associated resources were accessed from the local disk only after the Web page 235B was retrieved.

If the proxy is implementing act 313, rather than the client, then the short term resource may be prefetched even before receiving an express request for the resource from the client. A client request for a short term resource that the proxy has already requested will then not trigger a new request to the Web server. Accordingly, the latency time is preserved since the proxy did not need to wait for an express request for the short term resource from the client.

In addition, the proxy or server may determine that at least one of the plurality of prefetchable resources is to be retrieved only after the browser has been idle for a period of time (act 315), determine that the browser has been idle for at least the period of time (act 316), and only thereafter retrieve the long term resource (act 317). For example, such long term resources may include hyperlinked Web pages that have a possibility of having the associated hyperlink selected by the user.

Accordingly, the risk of delaying a user issued request resource due to a pending prefetch request by the browser for an unwanted hyperlinked Web page is significantly reduced. To further reduce this risk, the server may maintain statistical information regarding previous selections of a user or group of users to determine a probability of being selected by a user. That probability may be included in the network message to allow the client or proxy to determining whether acquiring the long term resource is useful. For example, as mentioned above, probability field 413 may be associated with each long term resource 411. After sensing browser idle time, the client or server may request the long term resources in order of decreasing probability. In addition, different required idle times may be required before requesting long term resources having different assigned selection probabilities so as further reduce the risk of delaying legitimate user requests.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of prefetching resources associated with a Web page, the method comprising the following:
an act of receiving a Web page in the form of a network message that includes a header portion and a body portion;
an act of reading identifications of a plurality of prefetchable resources associated with the Web page from the header portion of the network message; and
an act of retrieving at least some of the plurality of prefetchable resources read from the header portion of the network message.

2. A method in accordance with claim 1, wherein the Web page is a first Web page, wherein the act of retrieving at least some of the plurality of prefetchable resources read from the header portion of the network message comprises:
an act of retrieving a second Web page that is hyperlinked to the first Web page.

3. A method in accordance with claim 1, wherein the Web page is a first Web page, wherein the act of retrieving at least some of the plurality of prefetchable resources read from the header portion of the network message comprises:
an act of retrieving prefetchable resources associated with a second Web page that is hyperlinked to the first Web page.

4. A method in accordance with claim 1, wherein the act of retrieving at least some of the plurality of prefetchable resources read from the header portion of the network message comprises the following
an act of retrieving at least one of the plurality of prefetchable resources from a local persistent memory.

5. A method in accordance with claim 4, wherein the act of retrieving at least one of the plurality of prefetchable resources from a local persistent memory comprises the following:
an act of retrieving at least one of the plurality of prefetchable resources from a local disk.

6. A method in accordance with claim 1, wherein the act of retrieving at least some of the plurality of prefetchable resources read from the header portion of the network message comprises the following
an act of retrieving at least one of the plurality of prefetchable resources over a network.

7. A method in accordance with claim 1, wherein the act of retrieving at least some of the plurality of prefetchable resources read from the header portion of the network message comprises:
an act of retrieving one or more prefetchable resources selected from a group consisting of image, sound, video and executable files to be rendered with the Web page.

8. A method in accordance with claim 1, wherein the act of retrieving at least some of the plurality of prefetchable resources read from the header portion of the network message comprises:
an act of retrieving one or more prefetchable resources selected from a group consisting of image, sound, video and executable files to be rendered with a second Web page that is hyperlinked to the Web page.

9. A method in accordance with claim 1, wherein the act of receiving a Web page in the form of a network message that includes a header portion and a body portion comprises the following:
an act of receiving a HTTP response network message, wherein the header portion comprises a HTTP header portion of the HTTP response network message.

10. A method in accordance with claim 9, wherein the act of receiving a Web page in the form of network message comprises the following:
an act of receiving a HyperText Markup Language (HTML) in a body portion of the HTTP response network message.

11. A method in accordance with claim 1, wherein the act of reading identifications of a plurality of prefetchable resources associated with the Web page comprises the following:
an act of reading a plurality of Uniform Resource Identifiers from a pragma header of an HTTP response network message.

12. A method in accordance with claim 1, further comprising the following:
an act of determining that at least one of the plurality of prefetchable resource is to be retrieved substantially immediately; and
an act of substantially immediately initiating retrieval of the least one prefetchable resource that is to be retrieved immediately.

13. A method in accordance with claim 12, further comprising the following:
an act of determining that at least one of the plurality of prefetchable resource is to be retrieved only after the browser has been idle for a period of time;
an act of determining that the browser has been idle for at least the period of time; and
an act of retrieving the least one prefetchable resource that is to be retrieved only after the browser has been idle for the period of time.

14. A method in accordance with claim 1, further comprising the following:
an act of determining that at least one of the plurality of prefetchable resources is to be retrieved only after the browser has been idle for a period of time;
an act of determining that the browser has been idle for at least the period of time; and
an act of retrieving the least one prefetchable resource that is to be retrieved only after the browser has been idle for the period of time.

15. A method in accordance with claim 14, wherein the method is implemented by a browser on a client computer system, the method further comprising the following:
an act of the browser issuing a request for at least one of the at least some of the plurality of prefetchable resources; and
an act of acquiring the requested resource from a local cache that stores the requested resource, rather than one again retrieving the requested resource over a network.

16. A method in accordance with claim 15, further comprising:
an act of displaying the requested resource on the client computer system.

17. A method in accordance with claim 1, wherein the method is implemented by a proxy computer system.

18. A method in accordance with claim 17, further comprising the following:
an act of providing the received Web page to a client computer system, and wherein the act of retrieving at least some of the plurality of prefetchable resources is initiated without having first received an express request for any of the at least some of the plurality of prefetchable resources from the client computer system.

19. A computer program product for implementing a method of prefetching resources associated with a Web page, the computer program product comprising one or more computer-readable media having thereon the following:
computer-executable instructions for detecting receipt of a Web page in the form of a network message that includes a header portion and a body portion;
computer-executable instructions for reading identifications of a plurality of prefetchable resources associated with the Web page from the header portion of the network message; and
computer-executable instructions for causing to be retrieved at least some of the plurality of prefetchable resources read from the header portion of the network message.

20. A computer program product in accordance with claim 19, wherein the one or more computer-readable media are physical storage media.

21. A computer program product in accordance with claim 19, wherein the one or more computer-readable media further have thereon the following:
computer-executable instructions for determining that at least one of the plurality of prefetchable resources is to be retrieved substantially immediately; and
computer-executable instructions for substantially immediately initiating the retrieval of the least one prefetchable resource that is to be retrieved immediately.

22. A computer program product in accordance with claim 19, wherein the one or more computer-readable media further have thereon the following:
computer-executable instructions for determining that at least one of the plurality of prefetchable resources is to be retrieved only after the browser has been idle for a period of time;
computer-executable instructions for determining that the browser has been idle for at least the period of time; and
computer-executable instructions for initiating retrieval of the least one prefetchable resource that is to be retrieved only after the browser has been idle for the period of time.

23. One or more computer-readable media having thereon a data structure that represents a network message, the data structure comprising the following:
a body data field that represents a Web page; and
a header data field that represents a header portion of the network message, the header data field including a resource data field that identifies prefetchable resources associated with the Web page.

24. The one or more computer-readable media in accordance with claim 23, wherein the one or more computer-readable media are physical storage media.

25. The one or more computer-readable media in accordance with claim 23, wherein the header data field further comprises:
a type data field that identifies that a prefetchable resource is to be retrieved substantially immediately.

26. The one or more computer-readable media in accordance with claim 25, wherein the type data field is a first type data field that identifies some of the prefetchable resources as to be retrieved substantially immediately, wherein the data structure further comprises a second data field that identifies some of the prefetchable resources as to be retrieved only if and after there is a period of browser idle time.

27. The one or more computer-readable media in accordance with claim 23, wherein the data structure further comprises a data field that identifies some of the prefetchable resources as to be retrieved only if and after there is a period of browser idle time.

28. The one or more computer-readable media in accordance with claim 23, wherein the data structure is an HTTP response network message, wherein the body data field is a body portion of the HTTP response network message, and wherein the header data field is a header portion of the HTTP response network message.

29. A method of facilitating prefetching resources associated with a Web page, the method comprising the following:
an act of including a Web page in a body portion of the network message;
an act of including an identification of a plurality of prefetchable resources associated with the Web page in a header portion of the network message; and
an act of transmitting the network message to a client computer system.

30. A method in accordance with claim 29, wherein the act of transmitting the network message comprises an act of transmitting an HTTP response network message, and
wherein the act of including an identification of a plurality of prefetchable resources associated with the Web page in a header portion of the network message comprises an act of including the identification of the plurality of prefetchable resources in a HTTP header portion of the HTTP response network message.

31. A method in accordance with claim 29, wherein the act of generating a network message comprises an act of including a HyperText Markup Language (HTML) document in a body portion of the HTTP response network message.

32. A method of prefetching resources associated with a Web page, the method comprising the following:
an act of receiving a Web page in the form of a network message;
an act of reading from the network message one or more associated prefetchable resources that are to be prefetched substantially immediately;
an act of substantially immediately initiating retrieval of the one or more associated prefetchable resources that are to be retrieved substantially immediately;
an act of reading from the network message one or more associated prefetchable resources that are to be retrieved only after a period of idle time;
an act of determining that the period of idle time has passed; and
after the act of determining that the period of idle time has passed, an act of retrieving the one or more associated prefetchable resources that are to be retrieved only after the period of idle time.

33. A method in accordance with claim 32, wherein the act of reading from the network message one or more associated prefetchable resources that are to be retrieved substantially immediately comprises:
an act of retrieving one or more images to be rendered with the Web page.

34. A method in accordance with claim 32, wherein the act of reading from the network message one or more associated prefetchable resources that are to be downloaded substantially immediately comprises:
an act of retrieving one or more sound files to be rendered with the Web page.

35. A method in accordance with claim 32, wherein the Web page is a first Web page, wherein the act of reading from the network message one or more associated prefetchable resources that are to be retrieved only after a period of idle time comprises:
an act of retrieving a second Web page that is hyperlinked to the first Web page.

36. A method in accordance with claim 32, wherein the act of reading from the network message one or more associated prefetchable resources that are to be retrieved substantially immediately comprises:
an act of reading from a header portion of the network message the one or more associated prefetchable resources that are to be retrieved substantially immediately.

37. A method in accordance with claim 36, wherein the act of reading from a header portion of the network message the one or more associated prefetchable resources that are to be retrieved substantially immediately comprises the following:
an act of reading from an HTTP header portion of an HTTP response network message the one or more associated prefetchable resources that are to be retrieved substantially immediately.

38. A method in accordance with claim 32, wherein the act of reading from the network message one or more associated prefetchable resources that are to be retrieved substantially immediately comprises:
an act of reading from a body portion of the network message the one or more associated prefetchable resources that are to be retrieved substantially immediately.

39. A method in accordance with claim 38, wherein the act of reading from a body portion of the network message the one or more associated prefetchable resources that are to be retrieved substantially immediately comprises:
an act of reading from an HTML document in a body portion of an HTTP resource network message the one or more associated prefetchable resources that are to be retrieved substantially immediately.

40. A method in accordance with claim 32, wherein the act of reading from the network message one or more associated prefetchable resources that are to be retrieved only after a period of idle time comprises:
an act of reading from a header portion of the network message the one or more associated prefetchable resources that are to be retrieved only after a period of idle time.

41. A method in accordance with claim 32, wherein the act of reading from the network message one or more associated prefetchable resources that are to be retrieved only after a period of idle time comprises:
an act of reading from a body portion of the network message the one or more associated prefetchable resources that are to be retrieved only after a period of idle time.

42. A computer program product for implementing a method of prefetching resources associated with a Web page, the computer-program product comprising one or more computer-readable media having thereon the following:
computer-executable instructions for detecting receipt of a Web page in the form of a network message;
computer-executable instructions for reading from the network message one or more associated prefetchable resources that are to be retrieved substantially immediately;
computer-executable instructions for immediately initiating a retrieval of the one or more associated prefetchable resources that are to be retrieved substantially immediately;
computer-executable instructions for reading from the network message one or more associated prefetchable resources that are to be retrieved only after a period of idle time;
computer-executable instructions for determining that the period of idle time has passed; and
computer-executable instructions for causing the one or more associated prefetchable resources that are to be retrieved only after the period of idle time to be retrieved after the period of idle time.

43. A computer program product in accordance with claim 42, wherein the one or more computer-readable media are physical storage media.
